(19) United States
(12) Patent Application Publication
(10) Pub. No.: US 2014/0166498 A1
(43) Pub. Date: Jun. 19, 2014

(54) WATER PURIFICATION SYSTEM AND METHOD

(71) Applicants: John J. Orolin, West Linn, OR (US); Barbara A. Orolin, West Linn, OR (US)

(72) Inventors: John J. Orolin, West Linn, OR (US); Barbara A. Orolin, West Linn, OR (US)

(21) Appl. No.: 13/720,772

(22) Filed: Dec. 19, 2012

(51) Int. Cl. C02F 1/467

(52) U.S. Cl. CPC C02F 1/4672
USPC 205/743; 210/243; 210/97; 210/198.1; 210/638; 210/739

(57) ABSTRACT

Embodiments of the invention are directed to systems and methods for purifying fluids, such as water. In some embodiments, the water is first filtered by known filtering methods, such as by reverse osmosis or distillation. Once a flow is sensed in the fluid, electrolyte is added to the filtered fluid. Oxygen and hydrogen gas is then formed in the electrolytic filtered fluid via electrolysis to provide a treated fluid.

### BACKGROUND

1. Technical Field

Embodiments present of the present disclosure are directed to water purification systems and methods, and in particular, to water purification systems that include reverse osmosis and water distillation systems.

2. Description of the Related Art

Many benefits may be obtained through the use or consumption of water containing an elevated quantity of dissolved oxygen. Increased levels of dissolved oxygen in water have been shown to purify the water, removing and neutralizing a variety of biological and chemical contaminants. In addition, there are indications that animals and humans obtain considerable health benefits by drinking water with elevated levels of dissolved oxygen. Nutritionists and the medical community have published research indicating that the bacterial colonies residing in a human or animal's small and large intestines may play key roles in the development of many serious diseases. The bacterial colonies that cause these diseases are anaerobic, preferring to thrive in the intestines without oxygen. Highly oxygenated water has proven to be beneficial for animals in stopping serious diseases from occurring. Additionally, certain studies have shown that animals, including chickens and turkeys, may become heavier for a given grain consumption if their drinking water has elevated dissolved oxygen levels.

The dissolved oxygen content of water may be increased via electrolysis. According to known techniques, a current is supplied to a cathode and anode positioned in a water solution. A DC voltage is connected to the electrodes in the water. When current passes through the water it splits some of the water molecules into their component parts, causing the formation of hydrogen gas H₂ and oxygen gas O₂.

### BRIEF SUMMARY

Embodiments of the invention are directed to systems and methods for purifying fluids, such as water. In some embodiments, the water is first filtered by known filtering methods, such as by reverse osmosis (R/O) or distillation methods. In response to a fluid sensor sensing fluid flow, electrolyte is mixed with the filtered fluid to provide a mixed solution. Oxygen gas as O₂ and hydrogen gas as H₂ is then formed in the mixed solution via electrolysis to provide a treated fluid. In one or more embodiments, the filtered fluid is exposed to ultraviolet (UV) radiation prior to electrolysis to further purify the filtered fluid. In some embodiments, the treated fluid is exposed to the UV radiation after the electrolysis, which splits some of the O₂ molecules into single O elements for a brief period of time, which further purifies the treated fluid. In some embodiments, mineral additives are provided back into the treated fluid that may have been removed during the R/O or distillation filtering methods. The final fluid, which is ready for drinking, has a substantial amount of contaminants removed and proper minerals added thereby being able to provide increased health benefits to those that consume it.

One embodiment of the invention includes a method for receiving fluid through an inlet and filtering the fluid by a reverse osmosis process or distillation process to obtain a filtered fluid. The method further includes sensing flow of the filtered fluid, and in response to sensing the filtered fluid flow, adding electrolyte to the filtered fluid to provide an electrolytic filtered fluid. Oxygen gas is generated in the electrolytic filtered fluid by passing an electric charge through the electrolytic filtered fluid to obtain a treated fluid. The treated fluid may be removed through an outlet.

### BRIEF DESCRIPTION OF THE SEVERAL VIEWS OF THE DRAWINGS

FIG. 1 is a schematic illustration of a fluid purification system according to one embodiment of the present invention.

FIG. 2 is a schematic illustration of a fluid purification system according to another embodiment of the present invention.

FIG. 3 is a schematic illustration of a fluid purification system according to yet another embodiment of the present invention.

FIG. 4 is flow chart according to one embodiment of the present invention.

FIGS. 5a and 5b are top and side views, respectively, of an electrolytic cell according to one embodiment of the present invention.

### DETAILED DESCRIPTION

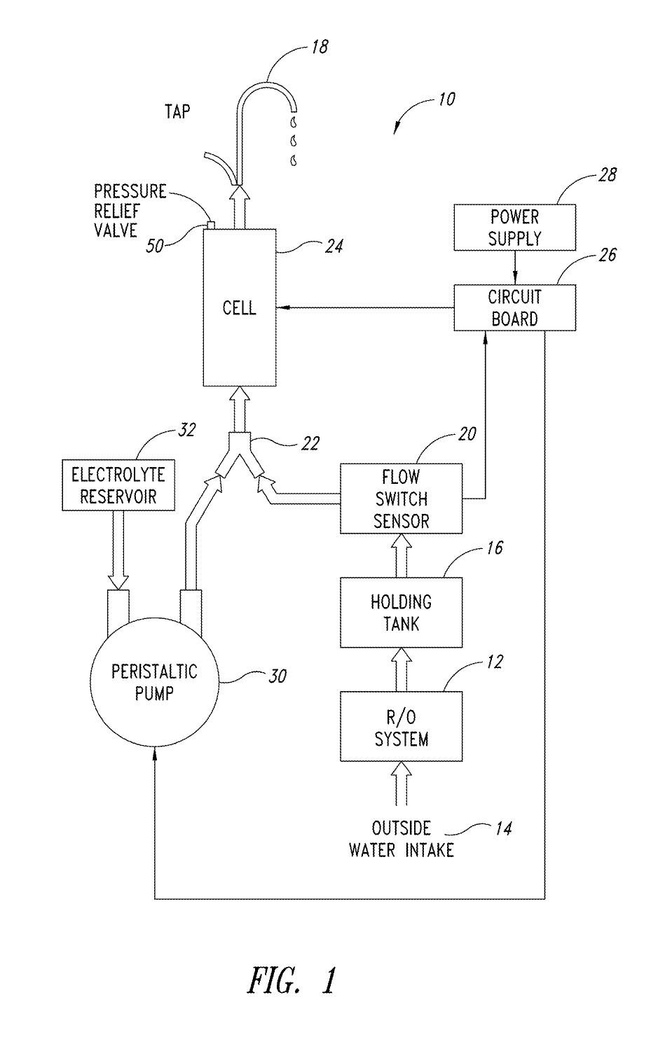

FIG. 1 shows a system 10 that includes an inlet of a reverse osmosis (R/O) system 12 in fluid communication with a water intake 14. Although the intake fluid is water, it is to be appreciated that other fluids may be used, such as beer and carbonated beverages. The R/O system 12 is configured to receive fluid from the water intake 14 and filter the received water by conventional methods to produce filtered water.

The R/O system 12 is of conventional design, and in one embodiment includes two carbon filters, a sediment filter, and an R/O membrane. Generally described, the R/O system 12 removes contaminants in the water that are received from the water intake. Such contaminants may include minerals, dissolved oxygen, anions, cations, and bacteria. Although the R/O system 12 effectively cleans the water, the filtered water can be unhealthy when consumed. In particular, the R/O filtered water is so pure that it is depleted of minerals and is known to remove minerals from plants and animals that consume it.

In general, R/O systems are slow compared to normal tap flow and thus take time to produce the filtered water at an expected rate for drinking. Therefore, in the illustrated embodiment, an outlet of the R/O system 12 is in fluid communication with an inlet to a holding tank 16 and provides the R/O filtered water to the holding tank 16 where the filtered water may be stored. The holding tank may be an inert hard plastic holding tank of varying size. In an embodiment in which the system 10 is used under a kitchen sink, the holding tank 16 is approximately between one and two gallons. It is to be appreciated that the holding tank 16 is optional and if a high flow first filter is used, it is not needed.

The holding tank 16 is in fluid communication with a tap 18 via a flow switch sensor 20, a mixing channel, such as a Y-fitting 22, and an electrocatalytic cell 24. In this flow line, an outlet of the holding tank 16 or the R/O system 12 is in fluid communication with an inlet of the flow switch sensor 20. An outlet of the flow switch sensor 20 is in fluid communication with a first inlet of the Y-fitting 22. An outlet of the Y-fitting 22 is in fluid communication with an inlet of the electrocatalytic cell 24. An outlet of the electrocatalytic cell 24 is in fluid communication with an inlet of the tap 18.

The tap 18 is used for delivering water out of the system 10 and is of conventional design. In general, the tap 18 includes a valve that is configured to close so that water is prevented from flowing out of the tap 18 and open so that water flows out of the tap 18, and the water that flows out of the tap is ready for drinking, making coffee, or other consumptions.

The flow switch sensor 20 is in electrical communication with a circuit board 26. When the tap 18 is opened so that water flows out of the system 10, the flow switch sensor 20 is configured to sense the fluid flow. The fluid flows from the holding tank 16 or R/O system 12 through the flow switch sensor 20 to the inlet of the Y-fitting 22. In response to sensing the fluid flow, the flow switch sensor 20 is configured to generate a signal indicative of the flow rate and provide the generated signal to electronics on the circuit board 26. In another embodiment, the system 10 may further include a toggle system to electrically activate and deactivate the system 10. When the valve of the tap 18 opens, a toggle may be depressed to activate all electrical parts of the system 10. When the valve closes, the toggle is released to deactivate the system 10. In this embodiment, it is assumed that the flow rate out of the tap 18 is opened generally at a constant rate and thus electrolytes and minerals added are input at this expected rate of flow.

The circuit board 26 includes conventional electronics to send and receive signals to components in the system 10 and is powered by a power supply 28 by conventional methods. The circuit board 26 is also in electrical communication with the cell 24 and a peristaltic pump 30. In response to receiving the generated signal from the flow switch sensor 20 indicative of fluid flowing through the sensor 20, electronics on the circuit board 26 are configured to generate one or more activation and control signals and one or more voltage signals.

Activation and control signals are provided to the peristaltic pump 30. In response to receiving the signals, the peristaltic pump 30 is configured to pump a particular amount of electrolyte into the fluid flow prior to the electrocatalytic cell 24 via a second inlet of the Y-fitting 22, thereby mixing the particular amount of electrolyte with the filtered fluid. The amount of electrolyte that is added to the filtered fluid will depend on the flow rate of the fluid. In that regard, the ratio of the electrolyte that is added to filtered fluid is adequately controlled. Electronics on the circuit board 26 are configured to control the speed at which the peristaltic pump 30 pumps electrolyte into the second inlet of the Y-fitting 22 to substantially correspond to the rate of flow of the water sensed by flow switch sensor 20. In particular, electronics on the circuit board 26 are configured to send control signals to the peristaltic pump 30 to control the rate at which the pump 30 pumps electrolyte into the second inlet of the Y-fitting 22.

By mixing electrolyte with the filtered fluid, conductance of the filtered water is increased. The electrolyte exits the Y-fitting 22 through the outlet along with the filtered fluid. In that regard, the electrolyte and filtered fluid are mixed together to form a mixed fluid and are provided together to the electrocatalytic cell 24.

The electrolyte may include compounds configured to add alkalinity to the filtered water, which raises the conductance of the filtered water. In one embodiment, the electrolyte may include mono-valent minerals, such as sodium bi-carbonate, sodium citrate, potassium bi-carbonate, or a combination thereof. In one embodiment, the ratio of electrolyte to filtered fluid is 1 mililiter (ml) of electrolyte to 473 ml (16 fluid oz) of purified water. In one embodiment, the electrolyte includes three parts sodium bi-carbonate, one part potassium bi-carbonate, and one half part sodium citrate. As indicated above, the mixture of the filtered water and the electrolyte increase the level of conductance in the mixture within the electrocatalytic cell 24. The conductance of the water may be raised to a range between 50 to 400 microsiemen (uS). In an embodiment in which the treated fluid is to be used for drinking, the conductance of the water may be raised to a range between 150 to 250 uS.

The reservoir 32 for holding the electrolyte may be replaceably connected to the peristaltic pump 30 so that the electrolyte may be easily replaced once depleted. In one embodiment, the concentration of electrolyte in the reservoir is of potassium bi-carbonate, solubility in water 33.7 g/100 ml at 20° C. In another embodiment, the concentration of electrolyte in the reservoir 32 is of sodium bi-carbonate, solubility in water 9.6 g/100 ml at 20° C.

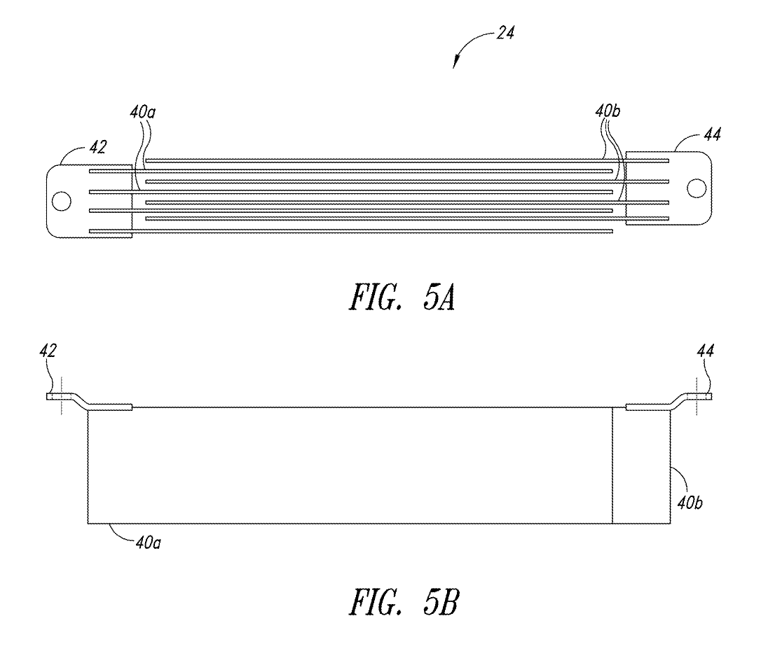

The electrocatalytic cell 24 may be of convention design, such as is described in U.S. Pat. No. 5,911,870, which is incorporated by reference in its entirety. FIGS. 5a and 5b show an exemplary electrocatalytic cell in top and side views. The electrocatalytic cell includes two sets of electrically conductive plates 40a, 40b, such as stainless steel plates, titanium plates, and the like. In some embodiments, the plates may be coated with iridium, ruthenium, or platinum. The first set of plates 40a extends from a first member 42 and a second set of plates 40b extends from a second member 44. Each of the first set of plates 40a are placed alternating with one of the second set of plates 40b.

One or more electrical signals, such as current or voltage signals, from electronics on the circuit board 26 are provided to the electrocatalytic cell 24. As indicated above, the electrical signals may be generated in response to receiving a signal from the flow sensor indicative of fluid flowing therethrough. One of the electrical signals generated by electronics on the circuit board 26 is provided to the first set of plates 40a. Another electrical signal may be provided to the second set of plates 40b. In that regard, the first set of plates 40a are placed at a first electrical potential and the second set of plates 40b are at a second, different electrical potential, thereby generating current in the filtered fluid in the electrocatalytic cell. It is to be appreciated that one of the sets of plates may be at ground.

The electrocatalytic cell 24 is configured to perform electrolysis or electrolyzed fluid treatment to the filtered fluid therein. The electrolyzed water treatment produces, gas, such as oxygen gas O₂ and hydrogen gas H₂ in the mixture to produce treated water. That is, when current is supplied, electricity passes through the water, splitting some of the water molecules into their component parts, causing the formation of hydrogen gas H₂ and oxygen gas O₂. As a result, the treated water has an increased level of dissolved oxygen, which is then provided to a user via the tap 18. Untreated tap water typically contains between 4 to 6 parts per million (ppm) of dissolved oxygen. In one embodiment, the treated water has approximately two to three times more dissolved oxygen (e.g., 8 to 18 ppm) when compared to untreated tap water. The higher levels of dissolved oxygen in the treated water provide high quality water and substantial health benefits to those that consume it. Some of the oxygen gas before dissolving into solution may be visible in the treated water upon exiting the tap as bubbles rising to a surface of a glass. The treated water may be readily consumed or bottled for later consumption.

The length, quantity, and spacing therebetween of the first and second sets of plates 40a, 40b may be selected to provide the desired amount of oxygen generation in accordance with known principles. In one embodiment, current in the range of 1 to 4 amps and a D.C. power supply of 24 volts or less is applied to the one of the sets of plates. For example, a 12 volt system could be used with amps in the range of 2 to 8. It is to be appreciated, however, that lower or higher voltages and amperes may be used.

It is to be appreciated that by filtering the water prior to treating the water via the electrocatalytic cell 24, the water is first filtered to remove various elements such as fluoride, chlorine, calcium, iron, and aluminum, and contaminants such as aerobic bacteria, tri-halomethanes i.e. chloroform, that may interfere with operation of the electrocatalytic cell. In particular, the various contaminants may adhere to the one or more of the first and second sets of plates of the electrocatalytic cell thereby reducing the ability of the electrocatalytic cell to produce oxygen and hydrogen gas in the water. Furthermore, by removing the minerals in the water via the R/O system prior to providing the water to the electrocatalytic cell, mineral build up, such as di-valent minerals, on the plates of the electrocatalytic cell does not occur.

As best shown in FIG. 1, the electrocatalytic cell 24 further includes a pressure relief valve 50. The pressure relief valve 50 ensures that the electrocatalytic cell 24 remains below suitable pressure levels. If an electrical signal is being applied to one of the sets of plates 40a, 40b of the electrocatalytic cell 24 for an extended period of time without fluid flowing through the cell, gas pressure may build up inside of the cell 24. In that regard, the pressure relief valve 50 will automatically open to release the gas or water pressure in the cell 24 to a lower pressure, such as atmosphere. In one embodiment, the pressure relief valve 50 is similar to those found on hot water heaters and will empty the excess gas or water into a drainpipe thereby not causing pressurized water to spill under the sink. In one embodiment, the pressure relief valve 50 may be actuated mechanically to open and close at a threshold pressure within the electrocatalytic cell 24. That is, once the pressure within the electrcatalytic cell 24 reaches the threshold pressure, the pressure relief valve 50 will open and excess gas can exit the electrocatalytic cell 24. When the pressure within the electrcatalytic cell 24 goes below the threshold pressure, the pressure relief valve 50 will close. It is to be appreciated that in some embodiments, the opening threshold pressure may be different from the closing threshold pressure. In another embodiment, the pressure relief valve 50 may be controlled to open and close by electronics on the circuit board 26 in response to receiving a pressure signal from a pressure sensor (not shown) in the electrocatalytic cell 24. In one embodiment, the pressure relief valve 50 may include a reset button to close the pressure relief valve 50 upon venting.

According to one embodiment, the electrocatalytic cell 24 is set on a timer to run for a selected time period or at certain time intervals when the water is turned off. When the tap 18 is off, the flow of water stops and the pump 50 stops inputting electrolytes into the water. The water remains stationary in the system, including inside the electrocatalytic cell 24.

In a first embodiment, right after the tap is turned off, the electrocatalytic cell 24 remains on for a set period of time, in one example, one minute, and in another example, two to four minutes, under the control of the electronics on the circuit board 26. With the electrocatalytic cell 24 operating, current passes through the stationary water in the cell and generates oxygen and hydrogen, thus charging the water in the cell with a high content of dissolved oxygen. This creates a supply of water present in the electrocatalytic cell 24 that is pre-charged with a high level of dissolved oxygen. After the preset time period, such as one to four minutes, the electrocatalytic cell 24 turns off. Then, at a later time, when a user turns on tap 18 to obtain drinking water, the first water to flow out of the electrocatalytic cell 24 through the tap 18 already has a high content of dissolved oxygen and is ready for drinking or other uses. The electrocatalytic cell 24 turns on as soon as the water starts to flow to also charge the flowing water with dissolved oxygen so that as water continues to flow through the electrocatalytic cell 24 and out the tap 18, it has a higher content of dissolved oxygen. Having the electrocatalytic cell 24 remain on for a set period of time to charge the stationary water with dissolved oxygen overcomes the possible issue that when water flows for the first few seconds out of tap 18, the cell 24 will not have been on a sufficient amount of time to create dissolved oxygen in the water flow before it is output from the tap 18.

In other embodiments, the electronics on the circuit board 26 has a timer function that operates the electrocatalytic cell 24 at selected time periods when flow is expected. For example, it is expected that each morning, the tap will be turned on for an early morning drink, for example, to make coffee. The electronics 26 will turn on the electrocatalytic cell 24 for a set time period, such as two to four minutes, each morning prior to 6:00 a.m., thus placing a high level of dissolved oxygen into the water, in preparation for use shortly thereafter. While the dissolved oxygen content will remain high in the water for several hours after the cell stops running, if it sits unused for 12 to 15 hours, some of the oxygen will leave the water and become a gas. By turning on the electrocatalytic cell 24 for a set amount of time after it has been idle for period of time, the water inside continues to have a high dissolved oxygen content when it is ready for use. As another example, if the electrocatalytic cell 24 goes over a certain number of hours, such as 8 or 12 hours, without being used, the electronics on the board 26 can be programmed to run it for a short period of time to recharge the water with dissolved oxygen. For example, every 8 hours, the cell can be run for one minute to keep the water in the system at a high level of oxygen content. The electronics on the board 26 can be programmed to turn on the cell 24 at certain times each day in anticipation of a future use, such as just prior to each meal or when children come home from school, or at a time interval schedule for a preset time each time it is turned on. The length of time that the cell 24 will be programmed to turn on will be selected based on the volume of water in the cell, the amount of dissolved oxygen that it is desired to be put into the cell, and other factors.

In a preferred embodiment, the entire system is a fluid tight, sealed system under pressure from the local community water source, as is standard in water systems in homes today. Since the cell 24 is a sealed system not open to the air except when pressure relief vent 50 opens, the dissolved oxygen that is put into the water in the cell 24 when there is no flow will remain in the water for several hours before escaping to the outside air. The time period and the frequency of turning the cell 24 on when water is not flowing will be kept sufficiently low that the generated oxygen and hydrogen gasses do not build up excess pressure to cause leaks or safety issues. The pressure relief vent 50 will ensure that in the unlikely event the pressure increases beyond a particular water pressure such that leaks or safety may be a concern, all excess pressure, air or liquid, will be allowed to escape quickly and harmlessly. Thus, while the pressure relief vent 50 is not required and is not present in all embodiments, having it present provides some additional level of safety in embodiments in which the cell 24 is activated without fluid flowing through the system.

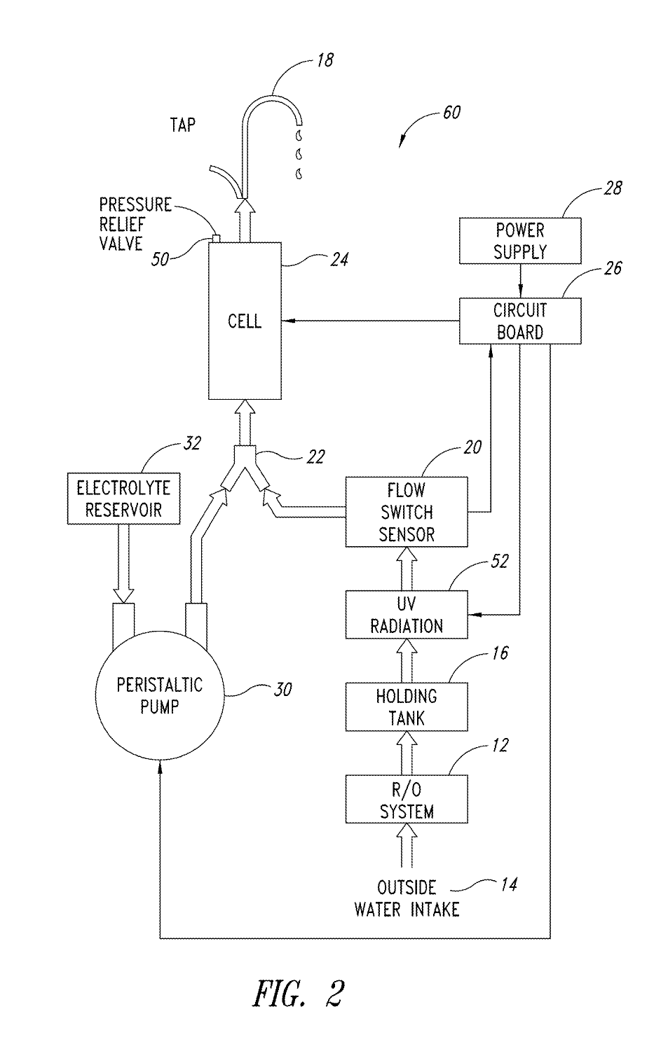

FIG. 2 shows another system according to another embodiment. The system 60 is substantially identical in components and operation to the system 10 of FIG. 1, except for the addition of an ultraviolet (UV) radiation device for exposing the filtered fluid to UV radiation prior to entering the electrocatalytic cell. In the interest of brevity and clarity, the same reference numerals are used, and an explanation of the function and operation of these components will not be repeated. In the system 60, an outlet of the holding tank 60 is in fluid communication with an inlet of a UV radiation device 52. The UV radiation device 52 is of conventional design and may include a transparent tube, such as a glass tube, that allows the filtered fluid to flow through the device. The UV radiation device 52 includes a UV radiation source configured to emit UV radiation through the transparent tube. In one embodiment, the UV radiation has a wavelength of about 254 nanometers. The UV radiation is configured to kill living viruses and microorganisms to further purify the water flowing through the transparent tube. This may be desired due to the possibility of bacterial growth that may grow on carbon or sediment filters in the R/O system 12 and that are transferred into the water while in the R/O system 12.

The UV radiation device 52 is in electrical communication with the electronics on the circuit board 26 and may be activated in response to the flow sensor 20 sensing flow there through.

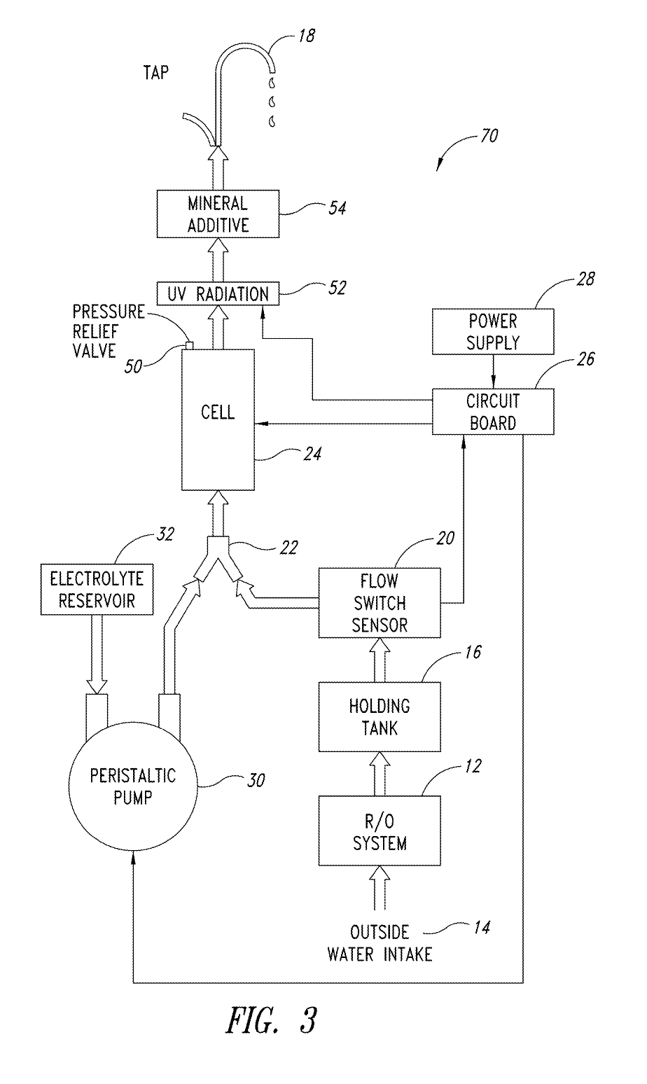

FIG. 3 shows another system 70 according to yet another embodiment. The system 70 is substantially identical in components and operation to the system 10 of FIG. 1, except for the addition of at least one of UV radiation device 52 and mineral additives 54 to the treated water upon exiting the electrocatalytic cell 24. In the interest of brevity and clarity, the same reference numerals are used, and an explanation of the function and operation of these components will not be repeated. It is to be appreciated that systems 60 and 70 may also be combined to provide yet another embodiment.

In the system 70, the outlet of the electrocatalytic cell 24 is in fluid communication with an inlet of a UV radiation device 52, such as the UV radiation device 52 described in reference to system 60. UV radiation treatment after the water exits the electrocatalytic cell 24 can cause O₂ molecules to split into single O elements (a powerful oxidizer), which can further eliminate bacteria that may remain in the treated fluid, thereby further cleaning the treated fluid.

Placing the UV radiation device 52 after the electrocatalytic cell 24 has particular benefits. The water exiting the cell has increased O₂ gas in the form of dissolved oxygen. When the UV rays strike the O₂ some of the O₂ gas is split for a brief time into single atoms of O. A single atom of O is very reactive and exists for only a brief time, during which time it will act to further clean and purify the water to remove viruses, bacteria, and other harmful substances in the water. Any atoms remaining of fluoride, chlorine, or other chemicals will be more likely to be neutralized by the single atoms of O. Thus any potentially harmful atoms will be neutralized by the abundance of single atoms of O, which are highly reactive. Even though each individual O atom will exist in the water for only a brief time, much less than one microsecond, as a result of the UV radiation, the application of a constant UV radiation after the cell provides further purifying effects on the water.

Additionally or alternatively, the water may receive one or more mineral additives 54, such as di-valent minerals, using known methods, such as by filters, to add nutrients to the fluid. That is, the water exiting the UV radiation device 52 may receive the mineral additives or the water leaving the electrocatalytic cell 24 may receive the mineral additives. For instance, minerals, such as magnesium or calcium, may be added to the fluid prior to exiting the tap. In one embodiment, the mineral additive is coral calcium, which not only adds calcium, but a host of many types of trace minerals considered essential to a healthy life style. In other embodiments, the mineral additive is in the form of calcium bi-carbonate and magnesium bi-carbonate, which increases the alkalinity in the purified water. The addition of the mineral additives to the fluid after exiting the electrocatalytic cell, as opposed to before entering the electrocatalytic cell, prevents plating of the minerals onto the plates of the electrocatalytic cell. The mineral additive allows for adding minerals that may have been removed by the R/O system.

Untreated tap water typically has a total dissolved solids (TDS) or an amount of minerals in the water from 40 to 400 mg/l. The systems disclosed herein are configured to output treated water from the tap 18 with a TDS in a desired range of 150 to 250 mg/l.

Oxidation reduction potential (ORP) is the measurement of water in terms of millivolts (mV). A positive mV value means fewer electrons are available in the water, and the water is referred to as an oxidant. Conversely, a negative mV value means more electrons are available in the water, and the water is referred to as an antioxidant. Untreated tap water typically has an ORP reading between +300 to +400 mV. This means the untreated tap water is an oxidant and is electron deficient. One reason for the high ORP in untreated tap water is due to the chlorine in tap water. The systems disclosed herein are configured to output treated water from the tap 18 with an ORP in a desired range of −300 mV to −400 mV. This means the treated water is antioxidant and is electron enriched.

Furthermore, the treated water is alkaline water and falls in a desired pH range of 8.5 to 9.5, while untreated tap water typically has a pH level between 6.8 and 7.2. It is to be appreciated that the electrolyte added to the R/O filtered water may control the alkalinity of the water.

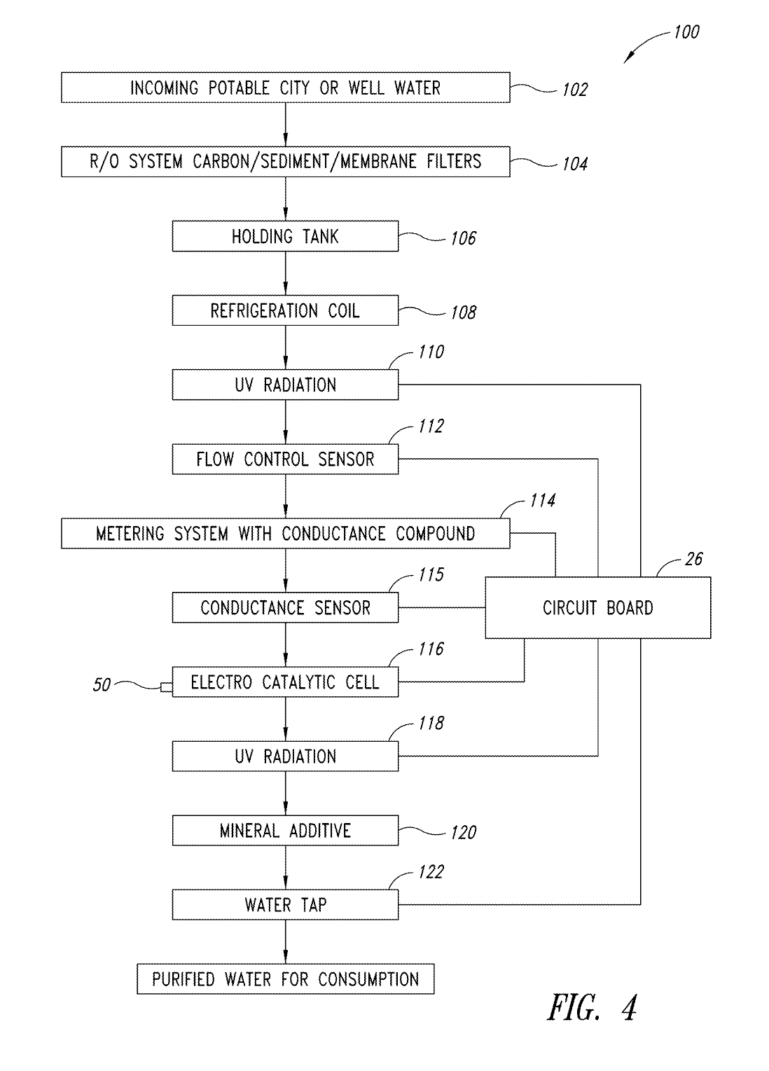

FIG. 4 illustrates a flow chart 100 for water or fluid flowing through a system, such as system 10, 60, 70, or a combination thereof. At step 102, water is provided to an R/O system, which treats the water to produce filtered water at step 104. The filtered water may then be provided to the holding tank at step 106. As filtered water exits the holding tank, the water may go through refrigeration coils to cool the water at step 108. The water may then be exposed to UV radiation at step 110. It is to be appreciated that the holding tank, refrigeration coils, and UV radiation are optional.

When water flows through the flow sensor at step 112, such as when the tap is opened to cause water to flow through the system, the flow sensor is activated. Upon activation of the flow sensor, a metering system for pumping electrolyte or a conductance compound into the system is activated by electronics on the circuit board at step 114. The electrolyte is provided to the electrocatalytic cell to mix with the filtered water, which is also provided to the electrocatalytic cell at step 116. Optionally, a conductance sensor may be provided and activated to sense the level of conductance being added to the electrocatalytic cell at step 115. The conductance sensor may be located in the electrocatalytic cell or before the electrolyte is added to the electrocatalytic cell. The conductance sensor provides information to electronics on the circuit board indicative of the amount of the electrolyte, such as potassium bi-carbonate solution, that is being added to the filtered water.

At step 118, the water that is treated in the electrocatalytic cell may optionally be exposed to UV radiation. At step 120, the treated water may optionally receive mineral additives. At step 122, the treated water flows through the tap and may be consumed.

In some embodiments, a system of lights, such as LED lights, are located at the base of the tap for troubleshooting the system devices when in use. In this embodiment, there may be three LED lights, such as green, yellow, and red. When none of the lights are activated this indicates the system is turned off. A steady green light indicates the system is in normal operation, while a blinking green light indicates water is flowing through the system. A steady yellow light may indicate one or more filters requiring changing, such as mineral, carbon, sediment, etc. A steady red light indicates the system needs maintenance, while a blinking red indicates the conductance fluid needs to be refilled.

The circuit board may include electronics programmed to turn off the system if a malfunction is occurring, in which case a steady red light at the base of the tap may be activated. It is to be appreciated that in response to receiving a signal from the flow switch sensor indicative of fluid flowing through the system, one or more of the following components of the system may be activated by electronics on the circuit board: a user counter, the electrocatalytic cell, the UV radiation lamps, metering device, including the peristaltic pump, conductance sensor, and lights on the tap. In response to receiving a signal from the flow switch sensor that fluid is no longer flowing through the system, the electronics on the circuit board may deactivate one or more the components.

The circuit board may also include an internal clock to remind the user that the system filters (carbon, sediment, and mineral) need to be changed. If the system is used often, the use counter will alert the user that the filters need to be changed soon when the internal clock indicates such. A steady yellow light at the base of the tap will indicate that system needs new filters. A reset button by the circuit board is depressed to renew the counter/timer after the filters are changed.

Although an R/O system is shown and described, it is to be appreciated that the R/O system may also be another filtering system, such as those that output highly purified water that additives may be useful prior to human consumption, such as a distilled water system. The above described systems and methods may be used not only with drinking fluid but also with fluids for use in hot tubs and spas or for use in cleaning fluid lines.

Conventional R/O systems are the best available technology for removing contaminants from potable water. All organic, inorganic cations and anions, along with bacteria are removed from the water. Untreated potable tap water typically contains 4 to 6 parts per million (ppm) of dissolved oxygen. The systems described herein can increase the dissolved oxygen content by two to three times the background level. Typically, untreated potable tap water has a total dissolved solids (TDS) or the amount of minerals in the water from 40 to 400 mg/l. Since R/O systems remove the TDS from the water it is important to replace those minerals back into the water. The systems described herein can add back into the water these desirable minerals in a range of 150 to 250 mg/l for human consumption or a range of 50 to 450 mg/l for other purposes.

Untreated potable tap water typically has a pH level between 6.8 to 7.2 which is considered neutral. Potable water that is alkaline with a pH greater than 7.0 is known to be healthier water to drink. The systems described herein will consistently increase the pH of the water to a range of 8.5 to 9.5. Untreated potable tap water typically has alkalinity because of its mineral content (e.g. “hard water”). However, some potable water sources have very little mineral content in the water (e.g. “soft water”). The systems described herein will increase the alkalinity consistently to a desirable range of 250 mg/l meaning the water is rich in mineral content.

Oxidation reduction potential (ORP) as measured in potable water is a measurement of the water in terms of millivolts (mV). The more positive the mV reading the fewer available electrons in the water, and the water is termed an oxidant. The more negative the ORP reading the more electrons are available in the water and the water is termed an antioxidant. Untreated potable tap water typically has an ORP reading of +300 to +400 mV meaning it has an oxidant property and is electron deficient. The systems described herein will shift the ORP reading in a negative direction about 300 to 400 mV meaning it has an antioxidant property and is electron enriched.

Electrolysis of water is the decomposition of water into oxygen and hydrogen due to an electric current being passed through the water. In that process an abundance of free “electrons” are made available:

2H2O→4H+O2+4e

A balanced state of health is that in which the body thrives and is most apt to operate to its capacity. However, if the body's environment is changed through poor diet, meaning by consumption of foods that have been oxidized by processing or cooking, a build of hydrogen ions results. The consequence of this is an acidic state and a low pH. To be healthy again, one needs only change the environment of his/her body by adding alkaline substances that have an abundance of “electrons” such as ionized water and raw fruits and vegetables.

Ionized water reflects the characteristics of raw foods in several ways. Ionized water has an abundance of electrons, as do raw foods. Ionized water has a negative charge, or ORP, as do raw foods. Ionized water possesses negative ions as do raw foods. Ionized water is alkaline as are raw foods. Ionized water is hydrating, as are raw foods. Ionized water is detoxifying as are raw foods. Ionized water provides the body with ionic (organic) minerals as do raw foods. True health is only found in nature. Ionized water mimics and magnifies nature better than any substance known.

The systems described herein perform the electrolysis of water without the use of a membrane (diaphragm) between the anode and cathode (plates of the cell). Both the anode and cathode water combine, producing highly oxygenated, alkaline, mineralized, antioxidant water. The electrolyte solution before the cell may be a combination of sodium and potassium bi-carbonate and sodium citrate. A post mineral filter after the electrocatalytic cell is made of coral calcium. It can provide up to 72 additional minerals into the water you drink without changing the taste of water. The chemical reactions that may occur are:

2H2O→4H+O2+4e

2K+2H2O→H2+2K+2OH

K+OH→KOH

KHCO3+H2O→KOH+H2CO3→CO2+H2O

The systems described The processed water is first purified with an R/O system, therefore removing all organic and inorganic compounds, including bacteria, solids, chloride, and trihalomethanes which are produced from the process of chlorination. No chlorine is produced at the anode because the R/O system removed the chloride in the potable tap water. The anode and cathode will have a “life time guarantee” because no mineral plating buildup will occur. This ensures maximum performance every time the system is used. Water clusters (bonds) are reduced in size. Thus the water better hydrates your body and is absorbed much easier. The treated water has alkalinity because the electrolyte used has minerals along with a post coral calcium mineral filter after the cell. The treated water is alkaline and falls in the pH range of 8.5 to 9.5. The processed water has two to three times the dissolved oxygen content of the incoming potable tap water. The water system uses low voltage D.C. requiring only 24 volts and 4 amps of energy. The systems described herein can be used to grow plants that are bigger than those grown from untreated water.

The electrolyte described herein is made up of three parts sodium bi-carbonate bi-carbonate and one part potassium bi-carbonate and one-half part sodium citrate. Our electrolyte container is made of inert Nalgene® plastic, and is 500 ml in size, and the dry electrolyte is pre-measured and sealed. Shelf life is indefinite at room temperature.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system comprising:
an inlet configured to receive a fluid;
a reverse osmosis system in fluid communication with the inlet and configured to filter the received fluid and to output a filtered fluid;
a pump configured to pump electrolyte;
a mixing channel having first and second inlets and an outlet, the first inlet being configured to receive the filtered fluid and the second inlet being configured to receive the electrolyte, the mixing channel being configured to mix the filtered fluid with the electrolyte to provide a mixed fluid at its outlet;
an electrocatalytic cell having an inlet in fluid communication with the outlet of the mixing channel, the electrocatalytic cell being configured to receive the mixed fluid and to generate oxygen gas in the mixed fluid and to provide a treated fluid at an outlet; and
a tap configured to output the treated fluid.

2. The system of claim 1, further comprising:
a flow sensor configured to generate a signal in response to sensing fluid flow of the mixed fluid; and
a circuit board that includes electrical components, at least one electrical component being configured to receive the signal from the flow sensor, at least one electrical component being configured to activate the electrocatalytic cell in response to the received signal.

3. The system of claim 2, further comprising an ultraviolet radiation device positioned in a flow path after the electrocatalytic cell and configured to expose the treated fluid to ultraviolet radiation before the tap outputs the treated fluid.

4. The system of claim 1 wherein the electrolyte includes sodium bi-carbonate, sodium citrate, potassium bi-carbonate, or a combination thereof.

5. The system of claim of claim 1, further comprising a mineral additive configured to add minerals to the treated fluid before the tap outputs the treated fluid.

6. The system of claim 1, further comprising an ultraviolet radiation device configured to expose the treated fluid to ultraviolet radiation before the tap outputs the treated fluid.

7. The system of claim 1, further comprising a holding tank configured to receive the filtered fluid from the reverse osmosis system and configured to store the filtered fluid before the filtered fluid is provided to the first inlet of the mixing channel.

8. A method comprising:
receiving fluid through an inlet;
filtering the fluid by a reverse osmosis process to obtain a filtered fluid;
sensing flow of the filtered fluid;
in response to sensing the filtered fluid flow, adding electrolyte to the filtered fluid to provide an electrolytic filtered fluid;
generating oxygen gas in the electrolytic filtered fluid by passing an electric charge through the electrolytic filtered fluid to obtain a treated fluid; and
removing the treated fluid through an outlet.

9. The method of claim 8 wherein generating oxygen gas in the electrolytic filtered fluid comprises passing the electrolytic filtered fluid through an electrocatalytic cell.

10. The method of claim 8 wherein adding electrolyte comprises adding sodium bi-carbonate, sodium citrate, potassium bi-carbonate, or a combination thereof.

11. The method of claim 8, further comprising adding minerals to the treated fluid.

12. The method of claim 11 wherein adding minerals comprises adding at least one of magnesium and calcium.

13. The method of claim 8, further comprising exposing the filtered fluid to ultraviolet radiation prior to adding electrolyte to the filtered fluid.

14. The method of claim 8, further comprising exposing the treated fluid to ultraviolet radiation prior to removing the treated fluid.

15. The method of claim 8 wherein the fluid is water.

16. The method of claim 8, further comprising storing the filtered fluid prior to sensing flow of the filtered fluid.

17. A method comprising:
receiving fluid through an inlet;
filtering the fluid to obtain a filtered fluid;
sensing flow of the filtered fluid;
in response to sensing the flow of the filtered fluid, adding conductance to the filtered fluid;
treating the filtered fluid by generating dissolved oxygen gas in the filtered fluid, the dissolved oxygen gas being generated by passing electric current through the filtered fluid while it flows through an electrocatalytic cell; and
removing the treated fluid through an outlet.

18. The method of claim 17 wherein filtering the fluid comprises filtering the fluid by a reverse osmosis process or distillation process.

19. The method of claim 17 wherein adding conductance comprises adding sodium bi-carbonate, sodium citrate, potassium bi-carbonate, or a combination thereof.

20. The method of claim 17, further comprising at least one of exposing the treated fluid to ultraviolet radiation and adding minerals to the treated fluid prior to removing the treated fluid from the outlet.
